(19) United States
(12) Patent Application Publication
(10) Pub. No.: US 2024/0251793 A1
(43) Pub. Date: Aug. 1, 2024

(54) AGRICULTURAL COMPOSITION AND USE THEREOF

(71) Applicant: Nippon Kayaku Kabushiki Kaisha, Chiyoda-ku, Tokyo (JP)

(72) Inventors: Hiroaki Hori, Kamisu-shi, Ibaraki (JP); Tsutomu Yonekawa, Kamisu-shi, Ibaraki (JP); Ryusei Matsuda, Kamisu-shi, Ibaraki (JP); Isao Aharen, Kamisu-shi, Ibaraki (JP)

(21) Appl. No.: 18/289,653

(22) PCT Filed: May 13, 2022
(86) PCT No.: PCT/JP2022/020160

§ 371 Date: Nov. 6, 2023

(30) Foreign Application Priority Data
May 21, 2021 (JP) 2021-085951

(51) Int. Cl. A01N 43/16; A01N 25/24; A01N 25/30; A01P 3/00

(52) U.S. Cl. CPC A01N 43/16; A01N 25/24; A01N 25/30; A01P 3/00

(57) ABSTRACT

An object of the present invention is to provide an agricultural composition capable of reducing influence of rainfall or the like in agrochemical spraying and obtaining a stable control effect. Another object of the present invention is to reduce adverse effects of natural environments such as rainfall and wind on crops, to assist the growth of crops, and to stabilize food supply.

The agricultural composition is an agricultural composition comprising (a) a fatty acid ester, (b) an unsaturated fatty acid or a salt thereof, and water, wherein the fatty acid ester (a): (i) comprises at least one fatty acid selected from a group consisting of saturated fatty acids having 12 to 22 carbon atoms as a fatty acid constituting the fatty acid ester, (ii) in which an alcohol produced by hydrolyzing the fatty acid ester is a tetrahydric or higher polyol, (iii) has an HLB of 5 or less, and (iv) is solid at 20° C. under normal pressure; and wherein the fatty acid ester (a) and the unsaturated fatty acid or a salt thereof (b) are emulsified or dispersed in water.

### TECHNICAL FIELD

The present invention relates to an agricultural composition. Specifically, the present invention relates to an agricultural composition which is classified as a food additive and comprises a fatty acid ester and a fatty acid salt having high safety, which is a functional composition for spraying excellent in adhesion to crops.

### BACKGROUND ART

In plant cultivation for the purpose of food supply, in order to obtain a stable yield of crops, an agrochemical is sprayed to a target plant to control diseases caused by plant pathogenic bacteria and feeding damage caused by plant pests in many cases. However, the agrochemical attached to a plant body is easily peeled, run off, or fell under a natural environment such as rainfall or wind, so that the effect is lost, and a sufficient control effect may not be obtained. In particular, in a season where rainfall frequently occurs such as rainy season, drying of the chemical solution sprayed under humid environment is delayed, and the chemical is less likely to be fixed to the plant, and a large amount of the chemical runs off due to rainfall. As a result, additional agrochemical spraying is forced, which causes problems such as an increase in control cost, a decrease in work efficiency, and an increase in environmental load.

In addition, the influence of rainfall or wind may also include an increase in infection risk due to the transmission of plant pathogenic bacteria or physical damage to plants. As a method to directly reduce such abiotic stress, there is a surrounding type cultivation method using a plastic greenhouse, a net, or the like, but for large crops such as fruit trees, it is often difficult to make practical use due to increased cultivation costs, reduced workability, and the like. Therefore, in many cases, only the infection risk is reduced by agrochemical spraying, and a further increase in cost and an increase in environmental load are problems.

In order to overcome these problems, a method for improving rain resistance of agrochemicals and suppressing leaching, peeling, runoff, or fall due to wind and rain has been developed. For example, Patent Literature 1 has reported that adhesion of an agrochemical to a plant is improved by using a cationic quaternary ammonium salt surfactant, and drug efficacy is improved by suppressing chemical runoff. Patent Literature 2 has reported that an agrochemical formulation composition obtained by combining an alkyl-modified silicone oil and an appropriate surfactant imparts rain resistance. As described above, an example has been reported in which adhesion of an agrochemical spray liquid to crops is stabilized and rain resistance is improved, but it cannot be said that it is desirable to use these components from the viewpoint of biotoxicity and environmental load.

A fatty acid ester is an emulsifier obtained from a plant-derived raw material, and since components generated by decomposition are only fatty acids and alcohols with low toxicity, the fatty acid ester has low environmental load and low biological toxicity, and is a component used also as a food additive. In recent years, a method for improving the rain resistance of agrochemicals using these fatty acid esters has been developed. For example, Patent Literature 3 has disclosed an adhesive agent composition for agrochemicals with high adherence properties in which a fatty acid triglyceride, a fatty acid, and a polyoxyalkylene sorbitol fatty acid ester are combined. Patent Literature 4 has reported that a spreading agent composition capable of imparting high rain resistance is obtained by combining a fatty acid ester and polyoxyethylene hydrogenated castor oil with a high number of moles added of ethylene oxide.

However, these conventional techniques cannot be said to have sufficient rain resistance to cope with humid conditions such as rainy season, and there is a demand for an agrochemical spraying technique capable of more quickly exhibiting high rain resistance.

### CITATION LIST

### Patent Literature

Patent Literature 1: JP 2012-51861 A
Patent Literature 2: JP 2004-189642 A
Patent Literature 3: JP 2015-163604 A
Patent Literature 4: JP 2017-25026 A

### SUMMARY OF INVENTION

### Technical Problem

The present invention has been made in view of the problems in the conventional techniques, and an object of the present invention is to provide an agricultural composition having rain resistance capable of reducing the influence of rainfall or the like in agrochemical spraying and obtaining a stable control effect. In particular, an object of the present invention is to provide an agricultural composition capable of rapidly exhibiting high rain resistance even in a high humidity environment such as rainy season.

### Solution to Problem

As a result of investigations to solve these problems, the present inventors have found that an agricultural composition obtained by emulsifying or dispersing a fatty acid ester (a) which (i) comprises at least one selected from a group consisting of saturated fatty acids having 12 to 22 carbon atoms as a fatty acid constituting the fatty acid ester, (ii) in which an alcohol obtained by hydrolyzing the fatty acid ester comprises a tetrahydric or higher polyol, (iii) has an HLB of 5 or less, and (iv) is solid at 20° C. under normal pressure, and a surfactant (b) comprising an unsaturated fatty acid salt in water imparts high rain resistance, and have completed the present invention.

That is, the present invention relates to inventions having the following configurations.
(1) An agricultural composition comprising (a) a fatty acid ester, (b) an unsaturated fatty acid or a salt thereof, and water,
wherein the fatty acid ester (a):
   (i) comprises at least one fatty acid selected from a group consisting of saturated fatty acids having 12 to 22 carbon atoms as a fatty acid constituting the fatty acid ester,
   (ii) in which an alcohol produced by hydrolyzing the fatty acid ester is a tetrahydric or higher polyol,
   (iii) has an HLB of 5 or less, and
   (iv) is solid at 20° C. under normal pressure; and
wherein the fatty acid ester (a) and the unsaturated fatty acid or a salt thereof (b) are emulsified or dispersed in the water.
(2) The agricultural composition according to (1), wherein the fatty acid constituting the fatty acid ester (a) comprises at least one fatty acid selected from a group consisting of lauric acid, myristic acid, palmitic acid, stearic acid, and behenic acid.
(3) The agricultural composition according to (1) or (2), wherein the fatty acid ester (a) is a polyglycerol fatty acid ester.
(4) The agricultural composition according to any one of (1) to (3), wherein the fatty acid ester (a) is a polyglycerol fatty acid ester derived from polyglycerol with a degree of polymerization of 3 to 10.
(5) The agricultural composition according to any one of (1) to (4), wherein the unsaturated fatty acid or a salt thereof (b) comprises an oleate.
(6) The agricultural composition according to any one of (1) to (5), wherein a weight ratio of the fatty acid ester (a) and the unsaturated fatty acid or a salt thereof (b) in the agricultural composition is 1 to 50 in (a)/(b).
(7) The agricultural composition according to any one of (1) to (6), wherein an oily droplet comprising the fatty acid ester (a) and the unsaturated fatty acid or a salt thereof (b) has a particle diameter of 50 μm or less in the water.
(8) The agricultural composition according to any one of (1) to (7), further comprising (c) a nonionic surfactant.
(9) The agricultural composition according to (8), wherein the nonionic surfactant (c) is a (polyoxyethylene) sorbitan fatty acid ester or a (poly)glycerin fatty acid ester with an HLB of 4 or more.
(10) The agricultural composition according to (8) or (9), wherein the nonionic surfactant (c) is a fatty acid ester, and wherein the fatty acid ester comprises oleic acid as a fatty acid constituting the fatty acid ester.
(11) The agricultural composition according to any one of (1) to (10), wherein the fatty acid ester (a) and the unsaturated fatty acid or a salt thereof (b) are emulsified or dispersed as an oily droplet melted and integrated.
(12) The agricultural composition according to any one of (1) to (11), wherein the content of the fatty acid ester (a) is higher than the content of the unsaturated fatty acid or a salt thereof (b) and the optional nonionic surfactant (c).
(13) A rain-resistant agricultural spreading agent comprising the agricultural composition according to any one of (1) to (12).
(14) An agrochemical composition comprising the agricultural composition according to any one of (1) to (12) and an agrochemical active ingredient.
(15) The agrochemical composition according to (14), comprising a fatty acid ester (a) at a concentration of 5 to 5000 ppm.

When the agricultural composition of the present invention is sprayed to form a coating film on a plant surface, it is possible to reduce adverse effects of natural environments such as rainfall and wind on crops, to assist the growth of crops, and to stabilize food supply. Thus, the following applications are also provided.
(16) A plant protection agent comprising the agricultural composition according to any one of (1) to (12).
(17) A plant protection agent for protecting from exposure to pathogenic bacteria transmitted by rain, wind, or the like, comprising the agricultural composition according to any one of (1) to (12).
(18) A plant protection agent for reducing stress received from a natural environment such as rain or wind, comprising the agricultural composition according to any one of (1) to (12).
(19) The plant protection agent according to any one of (16) to (18), comprising a fatty acid ester (a) at a concentration of 5 to 5000 ppm.

### Advantageous Effects of Invention

The present invention provides an agricultural composition having excellent adhesion. The agricultural composition of the present invention can impart high rain resistance by being added to an agrochemical spray liquid. All the fatty acid esters used in the present invention have low toxicity to living bodies, and many of them have been used as food additives, and thus the safety of the agricultural composition of the present invention is extremely high.

The agricultural composition of the present invention can impart excellent rain resistance at a component concentration equal to or lower than that of a known composition, and can rapidly exhibit rain resistance even under humid and rainy conditions such as rainy season. Therefore, the efficacy of the sprayed agrochemical can be maintained, and as a result, the number of times of chemical spraying, the spraying amount, the control cost, the environmental load, and the like are reduced.

### DESCRIPTION OF EMBODIMENTS

The agricultural composition of the present invention is an agricultural composition comprising (a) a fatty acid ester, (b) an unsaturated fatty acid or a salt thereof, and water, (hereinafter, also referred to as the “agricultural composition of the present invention” or the “composition of the present invention” in the present specification.) and has been completed based on the finding that a control effect is maintained by reducing runoff of an agrochemical component due to rainfall by using a component with less load on human body or environment as compared with conventional agricultural compositions. The term “rain resistance” in the present specification refers to performance for suppressing the sprayed agrochemical active ingredient from peeling, falling, and runoff from the plant surface due to rainfall.

The fatty acid ester in the present specification means a compound obtained by dehydration condensation of an aliphatic carboxylic acid (hereinafter, also referred to as “fatty acid”.) and a monohydric or higher alcohol.

The fatty acid ester (a) used in the agricultural composition of the present invention comprises at least one selected from saturated fatty acids having 12 to 22 carbon atoms as a constituent fatty acid, and examples thereof include lauric acid, myristic acid, palmitic acid, stearic acid, isostearic acid, behenic acid, and the like. Among them, lauric acid, myristic acid, palmitic acid, stearic acid, and behenic acid are preferable, stearic acid and behenic acid are more preferable, and stearic acid is particularly preferable. The saturated fatty acid having 12 to 22 carbon atoms may be a single kind or may comprise two or more kinds. The fatty acid ester (a) is preferably one comprising a saturated fatty acid having 12 to 22 carbon atoms.

The fatty acid ester (a) is a fatty acid ester in which an alcohol produced by hydrolyzing the fatty acid ester is a tetrahydric or higher polyol. Examples of such a polyol include polyglycerol, sugar, sugar alcohol, and the like. Examples of such fatty acid esters include polyglycerol fatty acid esters, sorbitan fatty acid esters, sorbitol fatty acid esters, sucrose fatty acid esters, and the like.

As the fatty acid ester (a), a polyglycerol fatty acid ester having an alcohol valence of 5 or more and a sucrose fatty acid ester are more preferable. A polyglycerol fatty acid ester derived from polyglycerol with a degree of polymerization of 3 to 10 is further preferable, and examples thereof include triglycerol fatty acid esters, tetraglycerol fatty acid esters, hexaglycerol fatty acid esters, and decaglycerol fatty acid esters. Among them, a decaglycerol fatty acid ester is particularly preferable.

The fatty acid ester (a) has an HLB of 5 or less. Hydrophile-Lipophile Balance (HLB) represents the degree of hydrophilicity and lipophilicity of a surfactant, and is an index expressed by a numerical value from 0 to 20. A low HLB indicates a highly lipophilic surfactant, and a high HLB indicates a highly hydrophilic surfactant. Therefore, a surfactant with a low HLB is easily compatible with a hydrophobic system, and a surfactant with a high HLB is easily compatible with a hydrophilic system. That is, it can be said that it is an index indicating which system the surfactant easily penetrates into the water/oil system. As the HLB value of the fatty acid ester, a numerical value derived by the following calculation method which is an empirical formula of Griffin is applied. As the saponification value and the acid value described below, values analyzed in accordance with the general test method of the food additive and the quasi-pharmaceutical product raw material standard are used.

$$HLB value = 20 ( 1 - S / A )$$

S: Saponification value of ester of surfactant,
A: Acid value of fatty acid constituting surfactant

The fatty acid ester (a) is solid at 20° C. under normal pressure. This means that the fatty acid ester (a) has a melting point of 20° C. or higher. The fatty acid ester (a) has a melting point of more preferably 40 to 100° C., further preferably 50 to 90° C.

Examples of the fatty acid ester (a) include those shown below. However, the fatty acid ester (a) is not limited to these examples. Examples thereof include tetraglycerol tristearate, tetraglycerol pentastearate, hexaglycerol heptabehenate, decaglycerol dodecabehenate, sorbitan tristearate, sucrose laurate, sucrose myristate, sucrose palmitate, sucrose stearate, and the like. Among them, decaglycerol decastearate is particularly preferable. Examples of commonly sold products include polyglycerol fatty acid esters such as SY-Glyster (trade name manufactured by Sakamoto Yakuhin Kogyo Co., Ltd.), sorbitan fatty acid esters such as Emazol (trade name, manufactured by Kao Corporation), and sucrose fatty acid esters such as Ryoto sugar ester (trade name, Mitsubishi-Chemical Foods Corporation).

The fatty acid ester (a) may be used alone or in a mixture of two or more kinds thereof.

The kind and amount of the fatty acid ester (a) comprised in the agricultural composition of the present invention are not particularly limited, and one kind or two or more kinds may be mixed in an arbitrary amount and used. However, usually, in consideration of cost effectiveness when used for agrochemical spraying, the application amount is preferably an amount considering use as an agrochemical spraying liquid with a content of a fatty acid ester (a) of 5 to 5000 ppm. Considering that the fatty acid ester (a) is usually diluted 500 to 20000 times with water when an agrochemical is used, the content of the fatty acid ester (a) in the agricultural composition of the present invention is preferably 0.1 to 99 mass %, more preferably 1 to 75 mass %, and particularly preferably 3 to 50 mass %. In the agricultural composition according to the present invention, the fatty acid ester (a) is preferably a maximum component among components other than water.

The unsaturated fatty acid or a salt thereof (b) is used for stably emulsifying and dispersing an oily component in an agricultural composition comprising the fatty acid ester (a) in water, or for improving adhesion and rain resistance to a target crop and stabilizing a control effect by a physicochemical characteristic obtained by combining with the fatty acid ester. The unsaturated fatty acid or a salt thereof (b) is an unsaturated fatty acid having 12 to 24 carbon atoms and having a carbon-carbon double bond or a salt thereof, and examples thereof include oleic acid, oleic acid metal salt, oleic acid ammonium salt, oleic acid amine salt, linoleic acid, linoleic acid metal salt, erucic acid, erucic acid metal salt, and the like. The unsaturated fatty acid or a salt thereof (b) is preferably oleic acid or oleate, more preferably oleic acid metal salt, and particularly preferably oleic acid sodium salt or oleic acid potassium salt.

The kind and amount of the unsaturated fatty acid or a salt thereof (b) comprised in the agricultural composition of the present invention are not particularly limited, and one kind or two or more kinds may be mixed in an arbitrary amount and used.

The agricultural composition of the present invention comprises the fatty acid ester (a) and the unsaturated fatty acid or a salt thereof (b) in an arbitrary ratio. However, if the amount of the unsaturated fatty acid or a salt thereof (b) is too large, there is a risk of causing a decrease in rain resistance and an adverse effect on plants. Therefore, the content of the unsaturated fatty acid or a salt thereof (b) is preferably smaller than that of the fatty acid ester (a). In addition, if the ratio of the fatty acid ester (a) is too large, emulsification or dispersibility in water is poor, separation or aggregation occurs, and long-term storage becomes difficult. Therefore, the weight ratio of (a)/(b) in the agricultural composition is more preferably 1 to 50, further preferably 2 to 30, and particularly preferably 3 to 15.

In the agricultural composition of the present invention, the oily component comprising the fatty acid ester (a) is emulsified or dispersed in the form of the oily droplet melted with the unsaturated fatty acid or a salt thereof (b), and other properties are not particularly limited. However, when particles of the dispersed oily droplets are extremely large, separation or aggregation occurs, and long-term storage becomes difficult. The particles of the oily droplet herein refer to particles dispersed in water and comprising the fatty acid ester (a) as a main component, and the size thereof is referred to as a “particle diameter”. The “particle diameter” in the present specification refers to a median when the volume median diameter of all particles comprised in the composition is represented by distribution.

The particle diameter is, for example, a particle diameter measured by a method using a laser diffraction particle size distribution measuring apparatus. Examples of commercially available measuring apparatus include SALD (product series name, Shimadzu Corporation) and the like.

The particle diameter of the agricultural composition of the present invention is preferably 50 μm or less, more preferably 0.1 to 50 μm, particularly preferably 0.1 to 10 μm, and particularly more preferably 0.1 to 5 μm.

The method for preparing the agricultural composition of the present invention is not particularly limited. However, in order to efficiently form a stable emulsified or dispersed state, a method in which the fatty acid ester (a) and the unsaturated fatty acid or a salt thereof (b) are heated to 60° C. or higher in water and mechanically stirred or sheared at a high temperature is preferable. Examples of an apparatus used for mechanical stirring or shearing include a Hiscotron, a homomixer, a dissolver, a colloid mill, a homogenizer, an ultrasonic stirrer, and the like.

The agrochemical composition of the present invention may comprise any additive component, and the kind and amount thereof are not limited. However, in order to improve the storage stability and convenience of the present invention, it is preferable to add the nonionic surfactant (c).

Examples of the nonionic surfactant (c) include a POE-POP block polymer, a polyoxyalkylene fatty acid ester, a polyoxyalkylene alkylbenzene fatty acid ester, an alcohol ethoxylate, a polyoxyalkylene alkylaryl ether, a polyoxyalkylenated organosiloxane, a propylene glycol fatty acid ester, a glycerin fatty acid ester, a polyoxyethylenated glycerin fatty acid ester, a polyoxyethylenated castor oil, a polyglycerol fatty acid ester, a sorbitan fatty acid ester, a polyoxyalkylene sorbitan fatty acid ester, a polyoxyethylene sorbitan fatty acid ester, and a sucrose fatty acid ester.

In consideration of the purpose of improving stability of emulsification or dispersion of the oily component comprising the fatty acid ester (a), the nonionic surfactant (c) has an HLB of preferably 4 or more, further preferably 6 to 18, more preferably 8 to 17, and particularly preferably 10 to 16.

The nonionic surfactant (c) is preferably a fatty acid ester, more preferably a (polyoxyethylene) sorbitan fatty acid ester or a (poly)glycerin fatty acid ester, and particularly preferably a polyoxyethylene sorbitan fatty acid ester. In addition, oleic acid is particularly preferable as the constituent fatty acid.

Examples of other additives in the agricultural composition of the present invention include a dispersant, a thickener, an anti-freezing agent, a preservative, a defoaming agent, and the like. Examples of the dispersant include polyvinyl alcohol, montmorillonite, and the like. Examples of the thickener include xanthan gum, welan gum, guar gum, carboxymethyl cellulose, hydroxymethyl cellulose, hydroxyethyl cellulose, hydroxymethyl propyl cellulose, cellulose nanofibers, aluminum silicate, magnesium silicate, and the like. Examples of the anti-freezing agent include ethylene glycol, diethylene glycol, polyethylene glycol, propylene glycol, polypropylene glycol, glycerin, methanol, ethanol, and the like. Examples of the preservative include benzisothiazolinone, methylisothiazolinone, triazine, thiabendazole, vitamin B, and the like. Examples of the defoaming agent include fatty acid, fatty acid ester, higher alcohol, silicone, modified silicone, and the like. In addition, these additives may be used alone or in a mixture of two or more kinds thereof, and any amount thereof may be used.

The agricultural composition of the present invention comprises the fatty acid ester (a) as a main component, and the unsaturated fatty acid or a salt thereof (b), and the nonionic surfactant (c) and optional other additives, and water. As a component excluding water in the agricultural composition, it is preferable that the fatty acid ester (a) is a maximum component. That is, an embodiment in which the content of the fatty acid ester (a) is higher than the content of the unsaturated fatty acid or a salt thereof (b) and the optional nonionic surfactant (c) is preferable. Preferably, the amount ratio of (a)/[(b)+(c)] is 1 to 20, and more preferably 2 to 10.

The agricultural composition of the present invention can be used as an agricultural spreading agent having rain resistance as a composition comprising the fatty acid ester (a) as a main component and not comprising active ingredients of chemical agrochemicals such as other bactericides, insecticides, acaricides, herbicides, and plant growth regulators. At that time, by mixing the agricultural composition of the present invention and an agrochemical active ingredient such as a bactericide, an insecticide, an acaricide, a herbicide, or a plant growth regulator when preparing a diluent and spraying the mixture, rain resistance can be imparted to the sprayed agrochemical.

The agricultural composition of the present invention can be formed into an agrochemical composition comprising active ingredients of chemical agrochemicals such as bactericides, insecticides, acaricides, herbicides, and plant growth regulators. This agrochemical composition is excellent in spreading to an application target plant and rain resistance against rainfall, and can obtain a stable control effect.

Examples of the insecticide include acrinathrin, acequinocyl, acetamiprid, acephate, amitraz, alanycarb, allethrin, isoxathion, imidacloprid, indoxacarb MP, esfenvalerate, ethiofencarb, ethiprole, ethylthiometon, etoxazole, etofenprox, emamectin benzoate, levamisole hydrochloride, oxamyl, cadusafos, cartap hydrochloride, carbosulfan, clothianidin, clofentezine, chromafenozide, chlorpyriphos, chlorfenapyr, chlorfluazuron, cycloprothrin, dinotefuran, cyfluthrin, dimethoate, spinosad, diazinone, thiacloprid, thiamethoxam, thiodicarb, thiocyclam oxalate, tebufenozide tebufenpyrad, tefluthrin, teflubenzuron, tralomethrin, tolfenpyrad, novaluron, halfenprox, bifenazate, bifenthrin, pymetrozine, pyraclofos, pyridafenthione, pyridaben, pyridalyl, pyriproxyfen, pyrimidifen, pyrimiphos-methyl, pyrethrin, fipronil, phenisobromolate, phenothiocarb, fluacrypyrim, flucythrinate, fluvalinate, flufenoxuron, propaphos, profenofos, hexythiazox, permethrin, bensultap, benzoepin, benfuracarb, Beauveria bassiana, Beauveria brongniartii, phosalone, machine oil, malathon, mesulfenphos, methomyl, methoxyfenozide, lufenuron, BPMC, BT (Bacillus thuringiensis), methidathion, fenitrothion, isoprocarb, fenthion, NAC, and the like.

Examples of the bactericides include acibenzolar-S-methyl, azoxystrobin, amobam, sulfur, isoprothiolane, ipconazole, iprodione, iminoctadine albesilate, iminoctadine triacetate, imibenconazole, echlomezole, oxadixyl, oxytetracycline, oxpoconazole fumarate, oxolinic acid, kasugamycin, carpropamid, quinomethionate, captan, kresoxim-methyl, chloroneb, cyazofamid, diethofencarb, diclocymet, diclomezine, dithianon, zineb, difenoconazole, cyflufenamid, diflumetorim, cyproconazole, cyprodinil, simeconazole, dimethomorph, cymoxanil, Pseudomonas fluorescens, pseudomonas CAB-02, ziram, wettable sulfur, Streptomycin, potassium bicarbonate, sodium bicarbonate, thiadiazine, tiadinil, thiabendazole, thiuram, thiophanate-methyl, thifluzamide, tecloftalam, tetraconazole, tebuconazole, copper, triadimefon, triazine, trichoderma atroviride, tricyclazole, triflumizole, trifloxystrobin, trifolin, tolclofos-methyl, Bacillus subtilis, validamycin, bitertanol, hydroxyisoxazole, pyrazophos, pyriphenox, pyrimethanil, pyroquilon, famoxadone, fenarimol, fenoxanil, ferimzone, fenbuconazole, fenhexamid, fthalide, furametpyr, fluazinam, fluoroimide, fludioxonil, flusulfamide, flutolanil, procymidone, propamocarb hydrochloride, propiconazole, propineb, probenazole, hexaconazole, benomyl, pefurazoate, pencycuron, boscalid, fosetyl, polyoxin, polycarbamate, manzeb, maneb, myclobutanil, mildiomycin, metasulfocarb, metominostrobin, mepanipyrim, organic copper, zinc sulfate, copper sulfate, edifenphos, iprobenfos, chlorothalonil, and the like.

Examples of the herbicides include ioxynil, azimsulfuron, asulam, atrazine, anilofos, alachlor, isouron, isoxaben, imazaquin, imazapyr, imazosulfuron, indanofan, esprocarb, ethoxysulfone, etobenzanide, chlorate, oxadiazon, oxadiargyl, oxaziclomefone, orthobencarb, oryzalin, cafenstrole, carfentrazone-ethyl, karbutilate, quizalofop-methyl, cumyluron, glyphosate ammonium salt, glyphosate isopropylamine salt, glyphosate potassium salt, glyphosate trimesium salt, glufosinate, clethodim, clomeprop, chlorphthalim, cyanazine, cyanate salt, cyclosulfamuron, diquat, dithiopyr, siduron, cinosulfuron, cyhalofop-butyl, diflufenican, dimethametryn, dimethenamid, simetryn, cinmethylin, sethoxydim, daimuron, dazomet, thifensulfuron-methyl, desmedipham, tetrapion, thenylchlor, tepraloxydim, triaziflam, triclopyr, trifluralin, trifloxysulfuron sodium salt, napropamide, nicosulfuron, paraquat, halosulfuron-methyl, bialaphos, bispyribac-sodium salt, bifenox, pyrazoxyfen, pyrazosulfuron-methyl, pyrazolate, pyrafulphenthion, pyriftalid, pyributicarb, pyriminobac-methyl, phenothiol, fentrazamide, phenmedipham, butachlor, butamifos, flazasulfuron, fluazifop, fluthiacet-methyl, flumioxazin, pretilachlor, prodiamine, propyzamide, bromacil, prometryn, bromobutide, florasuram, bethrodine, bensulfuron-methyl, benzofenap, benzobicyclon, bentazon sodium salt, benthiocarb, pendimethalin, pentoxazone, benfuresate, metamitron, metsulfuron-methyl, metolachlor, metribuzin, mefenacet, molinate, linuron, rimsulfuron, lenacil, ACN, simazine, dichlobenil, chlorthiamid, diuron, propanil, MCP, MCP isopropylamine salt, MCPB, MCPP, MDBA, MDBA isopropylamine salt, PAC, SAP, 2,4-PA, and the like.

The method for using the agrochemical composition of the present invention is not limited from the range of the normal method for using an agrochemical. However, in consideration of excellent rain resistance of the composition of the present invention and effective spraying of an agrochemical, it is preferable to apply a spray liquid obtained by diluting the agricultural composition of the present invention with water to a target plant or a pest together with an agrochemical active ingredient or an agrochemical formulation. As the agrochemical spray liquid, the concentration of the fatty acid ester (a) is preferably 5 to 5000 ppm, further preferably 10 to 500 ppm, and particularly preferably 20 to 250 ppm.

Also, the agricultural composition of the present invention may be used as a plant protection agent. The agricultural composition of the present invention can be sprayed to a target plant to form a coating film on the surface of the plant body, reduce exposure from pathogenic bacteria transmitted by rain, wind, or the like, and protect the plant. In addition, by forming the surface coating of the plant body, the agricultural composition of the present invention can reduce the stress that the sprayed plant receives from a natural environment such as rain or wind, and to protect the plant. When the agricultural composition of the present invention is used as a plant protection agent in the present invention, as the spray liquid, the concentration of the fatty acid ester (a) is preferably 5 to 5000 ppm.

### EXAMPLES

Hereinafter, the present invention will be described more specifically with reference to Examples. However, the embodiment is merely an example and does not limit the present invention.

Instruments and apparatuses used in the preparation of Examples and Comparative Examples, and analytical conditions are as follows.
Dispersion kettle: glass separable flask
Disperser: Hiscotron (MICROTEC CO., LTD.)
Particle size distribution meter: laser diffraction type particle size distribution measuring apparatus SALD-2200 (Shimadzu Corporation)
Measurement method: laser diffraction and laser scattering method
Measurement range: 0.03 to 1000 μm
Light source: semiconductor laser (wavelength 680 nm, output 3 mW)
Cell: flow cell type
Cell material: made of quartz glass
Software: WingSALD-2200
Analytical sample: prepared by adding water to the prepared composition so that the fatty acid ester (a) had a concentration of 0.1 to 5 wt % and dispersing the mixture.

Raw materials used in Examples and Comparative Examples are shown in Tables 1 to 3 below.
Group A; raw materials comprising a fatty acid ester (a) according to the present invention
Group B; raw materials comprising an unsaturated fatty acid (salt) (b) according to the present invention.
Group C; raw materials comprising a nonionic surfactant (c) according to the present invention
Group A′; raw materials comprising a fatty acid ester (a) used in Comparative Examples 3 to 8
Group B′; raw materials comprising an unsaturated fatty acid (salt) (b) used in Comparative Examples 9 to 16
Group C′; raw materials comprising a nonionic surfactant (c) used in Comparative Examples 21 to 25

TABLE 1
Groups A and A′

| | | | | | Fatty | | |
|---|---|---|---|---|---|---|---|
| | | | | | acid | | |
| | | | | | chain | Saturated/ | Alcohol |
| Group | Type | Component name | HLB | Property | length | unsaturated | valence |
| A | A1 | Decaglycerol decastearate | 3.8 | Solid | 18 | Saturated | 12 |
| | A2 | Hexaglycerol pentastearate | 4.5 | Solid | 18 | Saturated | 8 |
| | A3 | Tetraglycerol pentastearate | 2.6 | Solid | 18 | Saturated | 6 |
| | A4 | Decaglycerol dodecabehenate | 2.5 | Solid | 22 | Saturated | 12 |
| | A5 | Sucrose stearate | 1 | Solid | 18 | Saturated | 8 |
| | A6 | Sucrose palmitate | 1 | Solid | 16 | Saturated | 8 |
| | A7 | Sucrose laurate | 1 | Solid | 12 | Saturated | 8 |
| | A8 | Sorbitan tristearate | 2.1 | Solid | 18 | Saturated | 4 |
| A′ | A′1 | Hexaglycerol monostearate | 11.6 | Solid | 18 | Saturated | 8 |
| | A′2 | Tetraglycerol monostearate | 8.4 | Solid | 18 | Saturated | 6 |
| | A′3 | Long chain fatty acid triglyceride | 1 | Liquid | 18 | Unsaturated | 3 |
| | A′4 | Decaglycerol decaoleate | 3.3 | Liquid | 18 | Unsaturated | 12 |
| | A′5 | Sucrose oleate | 1 | Liquid | 18 | Unsaturated | 8 |
| | A′6 | POE (20) sorbitan stearate | 14.9 | Solid | 18 | Saturated | 4 |

TABLE 2
Groups B and B′

| Group | Type | Component name |
|---|---|---|
| B | B1 | Na oleate |
| | B2 | K oleate |
| B′ | B′1 | Semi-cured potassium tallowate |
| | B′2 | Na alkyl sulfate |
| | B′3 | Na alkylbenzenesulfonate |
| | B′4 | Dioctyl Na sulfosuccinate |

TABLE 3
Groups C and C′

| Group | Type | Component name |
|---|---|---|
| C | C1 | POE sorbitan oleate |
| | C2 | Sorbitan oleate |
| | C3 | Tetraglycerol monooleate |
| | C4 | Decaglycerol monooleate |
| C′ | C′1 | POE castor oil |
| | C′2 | POE (60) hydrogenated castor oil |
| | C′3 | Sorbitan laurate |
| | C′4 | POE sorbitan laurate |
| | C′5 | Diglycerol monocaprylate |

### Example 1

30 Parts by mass of decaglycerol decastearate (Sakamoto Yakuhin Kogyo Co., Ltd.; trade name SY-Glyster DAS-7S, HLB 3.8), 5 parts by mass of sodium oleate (NOF CORPORATION; trade name NONSOUL ON-A) and 65 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 2

30 Parts by mass of decaglycerol decastearate (Sakamoto Yakuhin Kogyo Co., Ltd.; trade name SY-Glyster DAS-7S, HLB 3.8), 25 parts by mass of a potassium oleate aqueous solution (NOF CORPORATION; trade name NONSOUL OK-1, purity 20 wt % potassium oleate aqueous solution) and 45 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 3

30 Parts by mass of decaglycerol decastearate (Sakamoto Yakuhin Kogyo Co., Ltd.; trade name SY-Glyster DAS-7S, HLB 3.8), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 2 μm.

### Example 4

30 Parts by mass of hexaglycerol pentastearate (Sakamoto Yakuhin Kogyo Co., Ltd.; trade name SY-Glyster PS-5S, HLB 4.5), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 4 μm.

### Example 5

30 Parts by mass of tetraglycerol pentastearate (Sakamoto Yakuhin Kogyo Co., Ltd.; trade name SY-Glyster PS-3S, HLB 2.6), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 2 μm.

### Example 6

30 Parts by mass of decaglycerol dodecabehenate (Sakamoto Yakuhin Kogyo Co., Ltd.; trade name SY-Glyster DBB-750, HLB 2.5), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 7

30 Parts by mass of sucrose stearate (Mitsubishi-Chemical Foods Corporation; trade name Ryoto sugar ester S-070, HLB about 1), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 4 μm.

### Example 8

30 Parts by mass of sucrose palmitate (Mitsubishi-Chemical Foods Corporation; trade name Ryoto sugar ester P-170, HLB about 1), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 9

30 Parts by mass of sucrose laurate (Mitsubishi-Chemical Foods Corporation; trade name Ryoto sugar ester L-195, HLB about 1), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 10

30 Parts by mass of sorbitan tristearate (Kao Corporation; trade name RHEODOL SP-S30V, HLB 2.1), 5 parts by mass of sodium oleate (NOF CORPOPATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 11

30 Parts by mass of decaglycerol decastearate (Sakamoto Yakuhin Kogyo Co., Ltd.; trade name SY-Glyster DAS-7S, HLB 3.8), 25 parts by mass of a potassium oleate aqueous solution (NOF CORPOPATION; trade name NONSOUL OK-1, purity 20 wt % potassium oleate aqueous solution), 2 parts by mass of polyoxyethylene (20) sorbitan oleate (TAKEMOTO OIL & FAT Co., Ltd.; trade name Newkalgen D-945, HLB 15), and 43 parts by mass of water were heated and stirred in a water bath at 80° C. for 10 minutes, and then dispersed at 5000 rpm for 5 minutes using a disperser to obtain an agricultural composition of the present invention having a particle diameter of 2 μm.

### Example 12

30 Parts by mass of decaglycerol decastearate (Sakamoto Yakuhin Kogyo Co., Ltd.; trade name SY-Glyster DAS-7S, HLB 3.8), 5 parts by mass of sodium oleate (NOF CORPORATION; trade name NONSOUL ON-A), 2 parts by mass of sorbitan oleate (TAKEMOTO OIL & FAT Co., Ltd.; trade name Newkalgen D-935, HLB 4.3), and 63 parts by mass of water were heated and stirred in a water bath at 80° C. for 10 minutes, and then dispersed at 5000 rpm for 5 minutes using a disperser to obtain an agricultural composition of the present invention having a particle diameter of 2 μm.

### Example 13

30 Parts by mass of decaglycerol decastearate (Sakamoto Yakuhin Kogyo Co., Ltd.; trade name SY-Glyster DAS-7S, HLB 3.8), 5 parts by mass of sodium oleate (NOF CORPORATION; trade name NONSOUL ON-A), 2 parts by mass of tetraglycerol monooleate (Sakamoto Yakuhin Kogyo Co., Ltd.; trade name SY-Glyster MO-3S, HLB 8.8), and 63 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 14

30 Parts by mass of decaglycerol decastearate (Sakamoto Yakuhin Kogyo Co., Ltd.; trade name SY-Glyster DAS-7S, HLB 3.8), 5 parts by mass of sodium oleate (NOF CORPORATION; trade name NONSOUL ON-A), 2 parts by mass of decaglycerol monooleate (Sakamoto Yakuhin Kogyo Co., Ltd.; trade name SY-Glyster MO-7S, HLB 12.9), and 63 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 15

5 Parts by mass of decaglycerol decastearate (Sakamoto Yakuhin Kogyo Co., Ltd.; trade name SY-Glyster DAS-7S, HLB 3.8), 1 part by mass of sodium oleate (NOF CORPORATION; trade name NONSOUL ON-A), 0.5 parts by mass of polyoxyethylene (20) sorbitan oleate (TAKEMOTO OIL & FAT Co., Ltd.; trade name Newkalgen D-945, HLB 15), and 93.5 parts by mass of water were heated and stirred in a water bath at 80° C. for 10 minutes, and then dispersed at 5000 rpm for 5 minutes using a disperser to obtain an agricultural composition of the present invention having a particle diameter of 2 μm.

### Example 16

45 Parts by mass of decaglycerol decastearate (Sakamoto Yakuhin Kogyo Co., Ltd.; trade name SY-Glyster DAS-7S, HLB 3.8), 7.5 parts by mass of sodium oleate (NOF CORPORATION; trade name NONSOUL ON-A), 3 parts by mass of polyoxyethylene (20) sorbitan oleate (TAKEMOTO OIL & FAT Co., Ltd.; trade name Newkalgen D-945, HLB 15), and 44.5 parts by mass of water were heated and stirred in a water bath at 80° C. for 10 minutes, and then dispersed at 5000 rpm for 5 minutes using a disperser to obtain an agricultural composition of the present invention having a particle diameter of 3 μm.

### Example 17

30 Parts by mass of decaglycerol decastearate (Sakamoto Yakuhin Kogyo Co., Ltd.; trade name SY-Glyster DAS-7S, HLB 3.8), 10 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 58 parts by mass of water were heated and stirred in a water bath at 80° C. for 10 minutes, and then dispersed at 5000 rpm for 5 minutes using a disperser to obtain an agricultural composition of the present invention having a particle diameter of 1 μm.

### Example 18

30 Parts by mass of decaglycerol decastearate (Sakamoto Yakuhin Kogyo Co., Ltd.; trade name SY-Glyster DAS-7S, HLB 3.8), 2 parts by mass of sodium oleate (NOF CORPORATION; trade name NONSOUL ON-A), 10 parts by mass of polyoxyethylene (20) sorbitan oleate (TAKEMOTO OIL & FAT Co., Ltd.; trade name Newkalgen D-945, HLB 15), and 58 parts by mass of water were heated and stirred in a water bath at 80° C. for 10 minutes, and then dispersed at 5000 rpm for 5 minutes using a disperser to obtain an agricultural composition of the present invention having a particle diameter of 5 μm.

### Comparative Example 1

30 Parts by mass of decaglycerol decastearate (Sakamoto Yakuhin Kogyo Co., Ltd.; trade name SY-Glyster DAS-7S, HLB 3.8) and 70 parts by mass of water were heated and stirred in a water bath at 80° C. for 10 minutes, and then dispersed at 5000 rpm for 5 minutes using a disperser. However, since the dispersion was rapidly separated and solidified, a stable agricultural composition of Comparative Example was not obtained.

### Comparative Example 2

5 Parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 93 parts by mass of water were heated and stirred in a water bath at 80° C. for 10 minutes, and then dispersed at 5000 rpm for 5 minutes using a disperser to obtain an agricultural composition of Comparative Example.

### Comparative Example 3

30 Parts by mass of hexaglycerol monostearate (Sakamoto Yakuhin Kogyo Co., Ltd.; trade name SY-Glyster MS-5S, HLB 11.6), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser. However, since the dispersion was rapidly separated and solidified, a stable agricultural composition of Comparative Example was not obtained.

### Comparative Example 4

30 Parts by mass of tetraglycerol monostearate (Sakamoto Yakuhin Kogyo Co., Ltd.; trade name SY-Glyster MS-3S, HLB 8.4), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser. However, since the dispersion was rapidly separated and solidified, a stable agricultural composition of Comparative Example was not obtained.

### Comparative Example 5

30 Parts by mass of olive oil (The Nisshin OilliO Group, Ltd.; HLB about 1), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of Comparative Example having a particle diameter of 1 μm.

### Comparative Example 6

30 Parts by mass of decaglycerol decaoleate (Sakamoto Yakuhin Kogyo Co., Ltd.; trade name SY-Glyster DAO-7S, HLB 3.3), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of Comparative Example having a particle diameter of 2 μm.

### Comparative Example 7

30 Parts by mass of sucrose oleate (Mitsubishi-Chemical Foods Corporation; trade name Ryoto sugar ester 0-180, HLB about 1), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser to obtain an agricultural composition of Comparative Example having a particle diameter of 2 μm.

### Comparative Example 8

30 Parts by mass of polyoxyethylene sorbitan stearate (Kao Corporation; trade name RHEODOL TW-S120V, HLB 14.9), 5 parts by mass of sodium oleate (NOF CORPORATION; trade name NONSOUL ON-A), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser. However, since the dispersion was rapidly separated and solidified, a stable agricultural composition of Comparative Example was not obtained.

### Comparative Example 9

30 Parts by mass of decaglycerol decastearate (Sakamoto Yakuhin Kogyo Co., Ltd.; trade name SY-Glyster DAS-7S, HLB 3.8), 5 parts by mass of semi-cured potassium tallowate (Kao Corporation; trade name KS Soap) and 65 parts by mass of water were heated and stirred in a water bath at 80° C. for 10 minutes, and then dispersed at 5000 rpm for 5 minutes using a disperser. As a result, a composition having a particle diameter of 3 μm was temporarily obtained, but the dispersion was rapidly solidified, thus a stable agricultural composition of Comparative Example was not obtained.

### Comparative Example 10

30 Parts by mass of decaglycerol decastearate (Sakamoto Yakuhin Kogyo Co., Ltd.; trade name SY-Glyster DAS-7S, HLB 3.8), 5 parts by mass of sodium dodecyl sulfate (Tokyo Chemical Industry Co., Ltd.), and 65 parts by mass of water were heated and stirred in a water bath at 80° C. for 10 minutes, and then dispersed at 5000 rpm for 5 minutes using a disperser. However, since the dispersion was rapidly solidified, a stable agricultural composition of Comparative Example was not obtained.

### Comparative Example 11

30 Parts by mass of decaglycerol decastearate (Sakamoto Yakuhin Kogyo Co., Ltd.; trade name SY-Glyster DAS-7S, HLB 3.8), 7.1 parts by mass of a sodium alkylbenzene sulfonate methanol solution (TAKEMOTO OIL & FAT Co., Ltd.; trade name Newkalgen A-41-B, purity 70 wt % sodium alkylbenzene sulfonate), and 62.9 parts by mass of water were heated and stirred in a water bath at 80° C. for 10 minutes, and then dispersed at 5000 rpm for 5 minutes using a disperser. However, since the dispersion was rapidly solidified, a stable agricultural composition of Comparative Example was not obtained.

### Comparative Example 12

30 Parts by mass of decaglycerol decastearate (Sakamoto Yakuhin Kogyo Co., Ltd.; trade name SY-Glyster DAS-7S, HLB 3.8), 7.1 parts by mass of a sodium dioctyl sulfosuccinate solution (TAKEMOTO OIL & FAT Co., Ltd.; trade name Newkalgen EP-70G, purity 70 wt % sodium dioctyl sulfosuccinate), and 62.9 parts by mass of water were heated and stirred in a water bath at 80° C. for 10 minutes, and then dispersed at 5000 rpm for 5 minutes using a disperser. However, since the dispersion was rapidly solidified, a stable agricultural composition of Comparative Example was not obtained.

### Comparative Example 13

30 Parts by mass of decaglycerol decastearate (Sakamoto Yakuhin Kogyo Co., Ltd.; trade name SY-Glyster DAS-7S, HLB 3.8), 5 parts by mass of semi-cured potassium tallowate (Kao Corporation; trade name KS Soap), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser. As a result, a composition having a particle diameter of 4 μm was temporarily obtained, but the dispersion was rapidly partly solidified, thus a stable agricultural composition of Comparative Example was not obtained.

### Comparative Example 14

30 Parts by mass of decaglycerol decastearate (Sakamoto Yakuhin Kogyo Co., Ltd.; trade name SY-Glyster DAS-7S, HLB 3.8), 5 parts by mass of sodium dodecyl sulfate (Tokyo Chemical Industry Co., Ltd.), 2 parts by mass of polyoxyethylene (20) sorbitan oleate (TAKEMOTO OIL & FAT Co., Ltd.; trade name Newkalgen D-945, HLB 15), and 63 parts by mass of water were heated and stirred in a water bath at 80° C. for 10 minutes, and then dispersed at 5000 rpm for 5 minutes using a disperser. As a result, a composition having a particle diameter of 5 μm was temporarily obtained, but the dispersion was rapidly partly solidified, thus a stable agricultural composition of Comparative Example was not obtained.

### Comparative Example 15

30 Parts by mass of decaglycerol decastearate (Sakamoto Yakuhin Kogyo Co., Ltd.; trade name SY-Glyster DAS-7S, HLB 3.8), 7.1 parts by mass of a sodium alkylbenzene sulfonate methanol solution (TAKEMOTO OIL & FAT Co., Ltd.; trade name Newkalgen A-41-B, purity 70 wt % sodium alkylbenzene sulfonate), 2 parts by mass of polyoxyethylene (20) sorbitan oleate (TAKEMOTO OIL & FAT Co., Ltd.; trade name Newkalgen D-945, HLB 15), and 60.9 parts by mass of water were heated and stirred in a water bath at 80° C. for 10 minutes, and then dispersed at 5000 rpm for 5 minutes using a disperser. As a result, a composition having a particle diameter of 5 μm was temporarily obtained, but the dispersion was rapidly partly solidified, thus a stable agricultural composition of Comparative Example was not obtained.

### Comparative Example 16

30 Parts by mass of decaglycerol decastearate (Sakamoto Yakuhin Kogyo Co., Ltd.; trade name SY-Glyster DAS-7S, HLB 3.8), 7.1 parts by mass of a sodium dioctyl sulfosuccinate solution (TAKEMOTO OIL & FAT Co., Ltd.; trade name Newkalgen EP-70G, purity 70 wt % sodium dioctyl sulfosuccinate), 2 parts by mass of polyoxyethylene (20) sorbitan oleate (TAKEMOTO OIL & FAT Co., Ltd.; trade name Newkalgen D-945, HLB 15), and 60.9 parts by mass of water were heated and stirred in a water bath at 80° C. for 10 minutes, and then dispersed at 5000 rpm for 5 minutes using a disperser. As a result, a composition having a particle diameter of 5 μm was temporarily obtained, but the dispersion was rapidly partly solidified, thus a stable agricultural composition of Comparative Example was not obtained.

### Comparative Example 17

30 Parts by mass of decaglycerol decastearate (Sakamoto Yakuhin Kogyo Co., Ltd.; trade name SY-Glyster DAS-7S, HLB 3.8), 5 parts by mass of polyoxyethylene (20) sorbitan oleate (TAKEMOTO OIL & FAT Co., Ltd.; trade name Newkalgen D-945, HLB 15), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 4 μm.

### Comparative Example 18

30 Parts by mass of decaglycerol decastearate (Sakamoto Yakuhin Kogyo Co., Ltd.; trade name SY-Glyster DAS-7S, HLB 3.8), 5 parts by mass of sorbitan oleate (TAKEMOTO OIL & FAT Co., Ltd.; trade name Newkalgen D-935, HLB 4.3), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 3 μm.

### Comparative Example 19

30 Parts by mass of decaglycerol decastearate (Sakamoto Yakuhin Kogyo Co., Ltd.; trade name SY-Glyster DAS-7S, HLB 3.8), 5 parts by mass of tetraglycerol monooleate (Sakamoto Yakuhin Kogyo Co., Ltd.; trade name SY-Glyster MO-3S, HLB 8.8), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 3 μm.

### Comparative Example 20

30 Parts by mass of decaglycerol decastearate (Sakamoto Yakuhin Kogyo Co., Ltd.; trade name SY-Glyster DAS-7S, HLB 3.8), 5 parts by mass of decaglycerol monooleate (Sakamoto Yakuhin Kogyo Co., Ltd.; trade name SY-Glyster MO-7S, HLB 12.9), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 5 μm.

### Comparative Example 21

30 Parts by mass of decaglycerol decastearate (Sakamoto Yakuhin Kogyo Co., Ltd.; trade name SY-Glyster DAS-7S, HLB 3.8), 5 parts by mass of polyoxyethylenated castor oil (TAKEMOTO OIL & FAT Co., Ltd.; trade name Newkalgen D-220, HLB 10.0), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 5 μm.

### Comparative Example 22

30 Parts by mass of decaglycerol decastearate (Sakamoto Yakuhin Kogyo Co., Ltd.; trade name SY-Glyster DAS-7S, HLB 3.8), 5 parts by mass of polyoxyethylenated hydrogenated castor oil (Kao Corporation; trade name EMANON CH-60(K), HLB 14), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 5 μm.

### Comparative Example 23

30 Parts by mass of decaglycerol decastearate (Sakamoto Yakuhin Kogyo Co., Ltd.; trade name SY-Glyster DAS-7S, HLB 3.8), 5 parts by mass of sorbitan laurate (TAKEMOTO OIL & FAT Co., Ltd.; trade name Newkalgen D-931, HLB 8.6), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 3 μm.

### Comparative Example 24

30 Parts by mass of decaglycerol decastearate (Sakamoto Yakuhin Kogyo Co., Ltd.; trade name SY-Glyster DAS-7S, HLB 3.8), 5 parts by mass of polyoxyethylene sorbitan laurate (TAKEMOTO OIL & FAT Co., Ltd.; trade name Newkalgen D-941, HLB 16.7), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 2 μm.

### Comparative Example 25

30 Parts by mass of decaglycerol decastearate (Sakamoto Yakuhin Kogyo Co., Ltd.; trade name SY-Glyster DAS-7S, HLB 3.8), 5 parts by mass of diglycerol monocaprylate (Sakamoto Yakuhin Kogyo Co., Ltd.; trade name SY-Glyster MCA-150, HLB 8.7), and 65 parts by mass of water were heated and stirred in a water bath at 80° C. for 10 minutes, and then dispersed at 5000 rpm for 5 minutes using a disperser to obtain an agricultural composition of Comparative Example having a particle diameter of 4 μm.

As Comparative Example 26, distilled water was used.

As Comparative Example 27, Abion-E; product name, Abion Corporation) was used.

### Test Example 1: Stability Test

The compositions obtained in Examples and Comparative Examples were placed in a poly container, stored at 20° C. for 1 week, and then confirmed whether the contents were solidified through a sieve of 100 mesh (mesh size 150 μm). In addition, from the appearance of the composition, it was confirmed whether there was no abnormality such as separation or solidification clearly.

### Evaluation Criteria

o: Uniformly dispersed in appearance, and no solid and the like were confirmed.
x: Separation and a solid were confirmed.

### Test Example 2: Rain Resistance Test

The compositions of Examples and Comparative Examples were added to a 2000-fold diluted solution of a chromafenozide 5′ flowable preparation ((product name) Matric flowable Nippon Kayaku Co., Ltd.) so as to have a fatty acid ester concentration of 150 ppm or 75 ppm to obtain a test solution.

Separately, one side of a 5 cm square parafilm was attached to the center of a 9 cm glass petri dish with a double-sided tape.

Exactly 1 mL of the test solution was placed on the parafilm piece using a whole pipette, and the parafilm piece was dried at normal temperature for 24 hours. Thereafter, the petri dish was inclined at an angle of about 45 degrees, and 100 mL of tap water was sprayed for 1 minute using a hand spray from a distance of about 30 cm in the vertical direction with respect to the petri dish. The petri dish was erected at 90° to remove the parafilm and water droplets in the petri dish, and then naturally dried again at normal temperature.

The parafilm after drying was placed in a test tube, 5 mL of acetonitrile was accurately added with a whole pipette, and the test tube was covered with a lid and strongly shaken about 50 times by hand. The obtained solution was analyzed by HPLC, and the residual ratio of the chemical on the parafilm before and after water spraying was calculated.

### Test Example 3: Instantaneous Rain Resistance Test

The compositions of Examples and Comparative Examples were added to a 500-fold diluted solution of a chromafenozide 5% flowable preparation ((product name) Matric flowable Nippon Kayaku Co., Ltd.) so as to have a fatty acid ester concentration of 150 ppm to obtain a test solution.

Separately, one side of a 5 cm square parafilm was attached to the center of a 9 cm glass petri dish with a double-sided tape.

The petri dish was allowed to stand horizontally, and 10 mL of the test solution was sprayed using a hand spray from about 30 cm diagonally 45 degrees from the top of the petri dish. Thereafter, the petri dish was allowed to stand in a thermostatic chamber set at a temperature of 25° C. and a humidity of 70% for 1 hour. Thereafter, the petri dish was inclined at an angle of about 45 degrees, and 50 mL of tap water was sprayed for 30 seconds using a hand spray from a distance of about 30 cm in the vertical direction with respect to the petri dish. The petri dish was erected at 90° to remove the parafilm and water droplets in the petri dish, and then naturally dried again at normal temperature.

The parafilm after drying was placed in a test tube, 5 mL of acetonitrile was accurately added with a whole pipette, and the test tube was covered with a lid and strongly shaken about 50 times by hand. The obtained solution was analyzed by HPLC, and the residual ratio of the chemical on the parafilm before and after water spraying was calculated.

The compositions of the test compositions and the results of Test Examples 1 to 3 are summarized in Tables 4 and 5.

TABLE 4
Test compositions and test results (Part 1)

| | A | | B | | C | | | | Rain resistance | | Instantaneous | |
|---|---|---|---|---|---|---|---|---|---|---|---|---|
| | Type | wt % | Type | wt % | Type | wt % | A/B | A:B:C | 150 ppm | 75 ppm | rain resistance | Stability |
| Example 1 | A1 | 30 | B1 | 5 | — | — | 6 | 100:17:0 | 94 | 90 | 86 | ◯ |
| Example 2 | A1 | 30 | B2 | 5 | — | — | 6 | 100:17:0 | 92 | 92 | 84 | ◯ |
| Example 3 | A1 | 30 | B1 | 5 | C1 | 2 | 6 | 100:17:7 | 98 | 95 | 92 | ◯ |
| Example 4 | A2 | 30 | B1 | 5 | C1 | 2 | 6 | 100:17:7 | 90 | 92 | 85 | ◯ |
| Example 5 | A3 | 30 | BI | 5 | C1 | 2 | 6 | 100:17:7 | 100 | 86 | 83 | ◯ |
| Example 6 | A4 | 30 | B1 | 5 | C1 | 2 | 6 | 100:17:7 | 96 | 94 | 85 | ◯ |
| Example 7 | A5 | 30 | B1 | 5 | C1 | 2 | 6 | 100:17:7 | 97 | 88 | 81 | ◯ |
| Example 8 | A6 | 30 | B1 | 5 | C1 | 2 | 6 | 100:17:7 | 93 | 92 | 88 | ◯ |
| Example 9 | A7 | 30 | B1 | 5 | C1 | 2 | 6 | 100:17:7 | 90 | 90 | 83 | ◯ |
| Example 10 | A8 | 30 | B1 | 5 | C1 | 2 | 6 | 100:17:7 | 93 | 85 | 82 | ◯ |
| Example 11 | A1 | 30 | B2 | 5 | C1 | 2 | 6 | 100:17:7 | 94 | 90 | 90 | ◯ |
| Example 12 | A1 | 30 | B1 | 5 | C2 | 2 | 6 | 100:17:7 | 93 | 88 | 88 | ◯ |
| Example 13 | A1 | 30 | B1 | 5 | C3 | 2 | 6 | 100:17:7 | 89 | 88 | 83 | ◯ |
| Example 14 | A1 | 30 | B1 | 5 | C4 | 2 | 6 | 100:17:7 | 95 | 90 | 88 | ◯ |
| Example 15 | A1 | 5 | B1 | 1 | C1 | 0.5 | 5 | 100:20:10 | 97 | 91 | 90 | ◯ |
| Example 16 | A1 | 45 | B1 | 7.5 | C1 | 3 | 6 | 100:17:7 | 97 | 92 | 93 | ◯ |
| Example 17 | A1 | 30 | B1 | 10 | C1 | 2 | 3 | 100:33:7 | 95 | 90 | 93 | ◯ |
| Example 18 | A1 | 30 | B1 | 2 | C1 | 10 | 15 | 100:7:33 | 93 | 85 | 84 | ◯ |

TABLE 5
Test compositions and test results (Part 2)

| | A | | B | | C | | | | Rain resistance | | Instantaneous | |
|---|---|---|---|---|---|---|---|---|---|---|---|---|
| | Type | wt % | Type | wt % | Type | wt % | A/B | A:B:C | 150 ppm | 75 ppm | rain resistance | Stability |
| Comparative | A1 | 30 | — | — | — | — | — | 100:0:0 | — | — | — | x |
| Example 1 | | | | | | | | | | | | (Separated) |
| Comparative | — | — | B1 | 5 | C1 | 2 | — | 0:17:7 | 68 (2000- | | 68 | ∘ |
| Example 2 | | | | | | | | | fold diluted | | | |
| | | | | | | | | | solution) | | | |
| Comparative | A′1 | 30 | B1 | 5 | C1 | 2 | 6 | 100:17:7 | — | — | — | x |
| Example 3 | | | | | | | | | | | | (Solidified) |
| Comparative | A′2 | 30 | B1 | 5 | C1 | 2 | 6 | 100:17:7 | — | — | — | x |
| Example 4 | | | | | | | | | | | | (Solidified) |
| Comparative | A′3 | 30 | B1 | 5 | C1 | 2 | 6 | 100:17:7 | 84 | 75 | 74 | ∘ |
| Example 5 | | | | | | | | | | | | |
| Comparative | A′4 | 30 | B1 | 5 | C1 | 2 | 6 | 100:17:7 | 83 | 64 | 82 | ∘ |
| Example 6 | | | | | | | | | | | | |
| Comparative | A′5 | 30 | B1 | 5 | C1 | 2 | 6 | 100:17:7 | 84 | 68 | 76 | ∘ |
| Example 7 | | | | | | | | | | | | |
| Comparative | A′6 | 30 | B1 | 5 | C1 | 2 | 6 | 100:17:7 | — | — | — | x |
| Example 8 | | | | | | | | | | | | (Solidified) |
| Comparative | A1 | 30 | B′1 | 5 | — | — | 6 | 100:17:0 | — | — | — | x |
| Example 9 | | | | | | | | | | | | (Solidified) |
| Comparative | A1 | 30 | B′2 | 5 | — | — | 6 | 100:17:0 | — | — | — | x |
| Example 10 | | | | | | | | | | | | (Solidified) |
| Comparative | A1 | 30 | B′3 | 5 | — | — | 6 | 100:17:0 | — | — | — | x |
| Example 11 | | | | | | | | | | | | (Solidified) |
| Comparative | A1 | 30 | B′4 | 5 | — | — | 6 | 100:17:0 | — | — | — | x |
| Example 12 | | | | | | | | | | | | (Solidified) |
| Comparative | A1 | 30 | B′1 | 5 | C1 | 2 | 6 | 100:17:7 | — | — | — | x |
| Example 13 | | | | | | | | | | | | (Solidified) |
| Comparative | A1 | 30 | B′2 | 5 | C1 | 2 | 6 | 100:17:7 | — | — | — | x |
| Example 14 | | | | | | | | | | | | (Solidified) |
| Comparative | A1 | 30 | B′3 | 5 | C1 | 2 | 6 | 100:17:7 | — | — | — | x |
| Example 15 | | | | | | | | | | | | (Solidified) |
| Comparative | A1 | 30 | B′4 | 5 | C1 | 2 | 6 | 100:17:7 | — | — | — | x |
| Example 16 | | | | | | | | | | | | (Solidified) |
| Comparative | A1 | 30 | — | — | C1 | 5 | — | 100:0:17 | 83 | 80 | 65 | |
| Example 17 | | | | | | | | | | | | |
| Comparative | A1 | 30 | — | — | C2 | 5 | — | 100:0:17 | 80 | 79 | 70 | ∘ |
| Example 18 | | | | | | | | | | | | |
| Comparative | A1 | 30 | — | — | C3 | 5 | — | 100:0:17 | 82 | 70 | 69 | ∘ |
| Example 19 | | | | | | | | | | | | |
| Comparative | A1 | 30 | — | — | C4 | 5 | — | 100:0:17 | 83 | 64 | 66 | ∘ |
| Example 20 | | | | | | | | | | | | |
| Comparative | A1 | 30 | — | — | C′1 | 5 | — | 100:0:17 | 53 | 48 | 55 | ∘ |
| Example 21 | | | | | | | | | | | | |
| Comparative | A1 | 30 | — | — | C′2 | 5 | — | 100:0:17 | 67 | 57 | 57 | ∘ |
| Example 22 | | | | | | | | | | | | |
| Comparative | A1 | 30 | — | — | C′3 | 5 | — | 100:0:17 | 78 | 67 | 58 | ∘ |
| Example 23 | | | | | | | | | | | | |
| Comparative | A1 | 30 | — | — | C′4 | 5 | — | 100:0:17 | 57 | 55 | 59 | ∘ |
| Example 24 | | | | | | | | | | | | |
| Comparative | A1 | 30 | — | — | C′5 | 5 | — | 100:0:17 | — | — | — | x |
| Example 25 | | | | | | | | | | | | (Solidified) |

| | | | | | | |
|---|---|---|---|---|---|---|
| Comparative | Water | — | — | 59 | 56 | — |
| Example 26 | | | | | | |
| Comparative | Paraffin 24% EW | — | — | 66 (500- | 68 | ∘ |
| Example 27 | | | | fold | | |
| | | | | diluted | | |
| | | | | solution) | | |

From the results of Test Examples 1 to 3, all of Examples 1 to 18 had high stability, and exhibited excellent rain resistance and instantaneous rain resistance also in the adhesion of the agrochemical component. On the other hand, all of Comparative Examples 1 to 27 had poor rain resistance compared with the agricultural composition of the present invention or were difficult to test due to poor stability.

### Test Example 4: Prevention Test for Sphaerotheca Cucurbitae

Examples 3 and 9 and Comparative Examples 26 and 27, diluted to an appropriate amount with water, were each sprayed on cucumber seedlings (variety: Tokiwa Fushinari, 4-leaf stage) at 20 mL/seedling using an electric sprayer (KIRIOU B-500, manufactured by Maruhachi Industry Co., Ltd.) and the seedlings were controlled at a constant temperature and humidity of 25° C. After two hours of the treatment, the Sphaerotheca cucurbitae spore suspension was sprayed. The number of lesions generated in the second to fourth true leaves after 11 days of the treatment was counted, and the control value was calculated by the following calculation formula.

$$Control value = ( 1 - ( Total number of lesions in treated area / Total number of lesions in tap water treated area ) ) \times 100$$

The results were summarized in Table 6.

TABLE 6
Test results of Test Example 4

| | | Number of lesions | | | | |
|---|---|---|---|---|---|---|
| | Dilution | Second | Third | Fourth | | Control |
| Sample | rate | true leaf | true leaf | true leaf | Total | value |
| Example 3 | 500 | 32 | 18 | 1 | 51 | 22.7 |
| Example 9 | 500 | 22 | 5 | 0 | 27 | 59.1 |
| Comparative | 500 | 34 | 22 | 3 | 59 | 10.6 |
| Example 27 | | | | | | |
| Comparative | — | 44 | 18 | 4 | 66 | 0 |
| Example 26 | | | | | | |
| (Tap water) | | | | | | |

The results of Test Example 4 showed that the agricultural compositions of Examples 3 and 9 suppressed the onset of Sphaerotheca cucurbitae as compared with Comparative Examples 26 and 27. Therefore, the agricultural composition of the present invention functions as a plant protection agent that protects agricultural plants from exposure to pathogenic bacteria transmitted by rain, wind, or the like.

The agricultural composition according to the present invention has excellent adhesion, rain resistance, and instantaneous rain resistance, and thus can suppress peeling, falling, and runoff of an agrochemical due to wind and rain. As a result, the effect of the agrochemical can be stabilized and sustained. In particular, it is possible to spray the agrochemical without concern even under humid and rainy conditions such as rainy season. Furthermore, since the agricultural composition of the present invention uses a component having secured safety to humans and the environment and can exhibit rain resistance at a low concentration, the number of times of spraying, the amount of spraying, the labor of spraying, and the cost of spraying can be reduced while suppressing the environmental load. Also, the present agricultural composition can be used as a rain-resistant agrochemical composition by being combined with another agrochemical composition when preparing an agrochemical spray liquid, and in this case, the effect of the combined agrochemical composition can be stabilized. In addition, the present agricultural composition can also be used as a plant protection agent, and by forming a coating film on a plant surface by spraying, it is possible to reduce adverse effects of natural environments such as rainfall and wind on crops, to assist the growth of crops, and to stabilize food supply.

1. An agricultural composition comprising (a) a fatty acid ester, (b) an unsaturated fatty acid or a salt thereof, and water,
wherein the fatty acid ester (a):
(i) comprises at least one fatty acid selected from a group consisting of saturated fatty acids having 12 to 22 carbon atoms as a fatty acid constituting the fatty acid ester,
(ii) in which an alcohol produced by hydrolyzing the fatty acid ester is a tetrahydric or higher polyol,
(iii) has an HLB of 5 or less, and
(iv) is solid at 20° C. under normal pressure; and
wherein the fatty acid ester (a) and the unsaturated fatty acid or a salt thereof (b) are emulsified or dispersed in the water.

2. The agricultural composition according to claim 1, wherein the fatty acid constituting the fatty acid ester (a) comprises at least one fatty acid selected from a group consisting of lauric acid, myristic acid, palmitic acid, stearic acid, and behenic acid.

3. The agricultural composition according to claim 1, wherein the fatty acid ester (a) is a polyglycerol fatty acid ester.

4. The agricultural composition according to claim 1, wherein the fatty acid ester (a) is a polyglycerol fatty acid ester derived from polyglycerol with a degree of polymerization of 3 to 10.

5. The agricultural composition according to claim 1, wherein the unsaturated fatty acid or a salt thereof (b) comprises an oleate.

6. The agricultural composition according to claim 1, wherein a weight ratio of the fatty acid ester (a) and the unsaturated fatty acid or a salt thereof (b) in the agricultural composition is 1 to 50 in (a)/(b).

7. The agricultural composition according to claim 1, wherein an oily droplet comprising the fatty acid ester (a) and the unsaturated fatty acid or a salt thereof (b) has a particle diameter of 50 μm or less in the water.

8. The agricultural composition according to claim 1, further comprising (c) a nonionic surfactant.

9. The agricultural composition according to claim 8, wherein the nonionic surfactant (c) is a (polyoxyethylene) sorbitan fatty acid ester or a (poly)glycerin fatty acid ester with an HLB of 4 or more.

10. The agricultural composition according to claim 8, wherein the nonionic surfactant (c) is a fatty acid ester, and wherein the fatty acid ester comprises oleic acid as a fatty acid constituting the fatty acid ester.

11. The agricultural composition according to claim 1, wherein the fatty acid ester (a) and the unsaturated fatty acid or a salt thereof (b) are emulsified or dispersed as an oily droplet melted and integrated.

12. The agricultural composition according to claim 1, wherein the content of the fatty acid ester (a) is higher than the content of the unsaturated fatty acid or a salt thereof (b) and the optional nonionic surfactant (c).

13. A rain-resistant agricultural spreading agent comprising the agricultural composition according to claim.

14. An agrochemical composition comprising the agricultural composition according to claim 1 and an agrochemical active ingredient.

15. (canceled)

16. A plant protection agent comprising the agricultural composition according to claim 1.

17. (canceled)

18. A plant protection agent for protection from exposure to pathogenic bacteria transmitted by rain or wind, comprising the agricultural composition according to claim 1.

19. (canceled)

20. A plant protection agent for reducing stress received from a natural environment such as rain or wind, comprising the agricultural composition according to claim 1.

21. (canceled)

22. The agricultural composition according to claim 8, wherein the fatty acid ester (a) and the unsaturated fatty acid or a salt thereof (b) are emulsified or dispersed as an oily droplet melted and integrated.

23. The agricultural composition according to claim 8, wherein the content of the fatty acid ester (a) is higher than the content of the unsaturated fatty acid or a salt thereof (b) and the optional nonionic surfactant (c).

24. A rain-resistant agricultural spreading agent comprising the agricultural composition according to claim 8.

25. An agrochemical composition comprising the agricultural composition according to claim 8 and an agrochemical active ingredient.

26. A plant protection agent comprising the agricultural composition according to claim 8.

27. A plant protection agent for protection from exposure to pathogenic bacteria transmitted by rain or wind, comprising the agricultural composition according to claim 8.

28. A plant protection agent for reducing stress received from a natural environment such as rain or wind, comprising the agricultural composition according to claim 8.
